(19) United States
(12) Patent Application Publication
(10) Pub. No.: US 2006/0180003 A1
(43) Pub. Date: Aug. 17, 2006

(54) Percussion instrument with improved damping mechanism

(76) Inventor: Franciscus Johannes Marie Swinkels, Thorn (NL)

Correspondence Address: MICHAELSON & ASSOCIATES, P.O. BOX 8489, RED BANK, NJ, 07701, US

(21) Appl. No.: 11/273,577

(22) Filed: Nov. 14, 2005

Related U.S. Application Data
(60) Provisional application No. 60/628,011, filed on Nov. 15, 2004.

(30) Foreign Application Priority Data
Nov. 12, 2004 (NL) 1027490

(51) Int. Cl. G10D 13/08

(52) U.S. Cl. 84/402

(57) ABSTRACT

The invention relates to a percussion instrument (1), such as for instance a glockenspiel, xylophone, vibraphone or marimba, comprising at least two rows of bars (3, 5) arranged next to each other, and a damping mechanism (10) for damping vibrations generated in the bars (7, 8) when the instrument (1) is being played, the damping mechanism (10) comprising a damping body (14), which can abut by a contact surface against the bars (7, 8), while the rows of bars (3, 5) mutually differ in height, and the contact surface comprises at least two partial surfaces, of which a first partial surface is arranged to abut against a first row of bars (3) and a second partial surface is arranged to abut against a second, higher row of bars (5). The damping mechanism can further comprise conversion means (25), in order to set an initial damping situation, allowing the percussion instrument (1) either to be standardly damped or to be standardly not damped.

The invention relates to a percussion instrument with improved damping mechanism. More particularly, the invention relates to a percussion instrument provided with at least two rows of bars situated next to each other, such as a glockenspiel, vibraphone, xylophone or marimba, and a damping mechanism arranged between or under these rows, for damping out vibrations operatively generated in the bars and attendant sounds.

Such percussion instruments are known. The damping mechanism of these percussion instruments provides a damping body, in particular a damping beam, which is arranged under the rows and in a standard factory setting either abuts against the bars, so that these are damped continuously, or, conversely, is clear of them, so that the bars are standardly not damped. The known damping mechanism furthermore comprises operating means, such as a foot pedal with suitable transmission means, to bring the damping body temporarily out of the standard set position, that is, to an undamped, or, conversely, a damped position.

A disadvantage of this known damping system is that it is unsuitable for use with percussion instruments where the rows of bars are mutually different in height and the bars partly overlap. Such an arrangement provides the advantage that a more compact instrument is obtained, which can be readily played by a musician because he does not need to reach so far to strike the different bars. The bars can moreover be presented in a convenient manner. For instance, a first row of bars can comprise all whole notes and a second row, situated above the first row, all half-notes. However, a drawback is that in such instruments a damping mechanism as described above does not work, at least can merely damp the lower or the upper row. In practice, known percussion instruments having such an arrangement of the bars, such as for instance a glockenspiel, are therefore normally not damped.

A further disadvantage of the known damping system is that the damping body will regularly have to be operated for a prolonged time to remove the factory-set initial position if the damping requirements of the respective piece of music (that is, chiefly damped, or conversely, chiefly undamped) do not match the factory setting (undamped or damped, respectively). This is strenuous and hampers the musician's freedom of movement.

The object of the invention is to provide a percussion instrument of the above-described type, in which at least a part of the disadvantages of the known instruments are eliminated. In particular, the object of the invention is to provide a percussion instrument with a damping mechanism that is suitable for use in a percussion instrument with rows of bars of unequal height.

Furthermore, the object of the invention is to provide a percussion instrument with a damping mechanism whose damping condition in an unoperated initial position is settable as desired between damped or undamped.

These and other objects are at least partly achieved with a percussion instrument according to the invention characterized by the features of claim 1.

By providing the damping mechanism, in particular a damping body thereof, with a divided contact surface, with at least two partial surfaces, the freedom is obtained of designing these partial surfaces such that, in a damped position, they can each abut against a different row of bars. In this way, differences in height between the respective rows can be simply compensated by providing the partial surfaces with a corresponding difference in height between them. Accordingly, percussion instruments having several rows of bars differing in height can be provided with adequate damping, while these rows can be damped with a single damping body, without operating means of this damping body requiring adaptation to that end.

In an advantageous embodiment, the partial surfaces of the damping body are constructed such that they can extend at least partly through the interspaces between adjacent bars of a row. The damping body can then have a first partial surface extending under a lower row of bars and a second partial surface can extend from this damping body through the interspaces between the bars of the first row, as far as the bars of a row situated above the first row. In this way, overlapping bars can be damped at their most favorable location, that is, at their (overlapping) ends. Moreover, in this way, the space under the middle of the bars can be kept clear for any other parts, such as resonator tubes and/or vibration means.

In a particularly advantageous embodiment, the different partial surfaces may be formed by pins having different lengths, while pins having corresponding lengths in each case jointly form one partial surface. Thus, in a relatively simple manner, partial surfaces for different heights of rows can be formed, while the pins can be simply dimensioned and positioned such that they can extend into and through the interspaces between the bars.

In further elaboration, a damping mechanism according to the invention may furthermore be provided with conversion means, with which the initial position of the damping mechanism can be set as desired between a position in which the bars are standardly damped and a position in which the bars are standardly not damped. Such conversion means are especially advantageous for quasi-static damping wishes, whereby prolonged damping or, conversely, no damping is desired. For the purpose of fast, brief damping changes, a musician can work with standard operating means, known per se, such as a foot pedal, with which damping can be briefly switched on or off. The musician can thus assess in advance whether a particular piece of music requires more, or less, damping, and set the initial position of the damping mechanism accordingly. Consequently, operation of the instrument can be considerably simplified, because situations in which the operating means are to be activated protractedly by a musician can be avoided.

The further subclaims set forth further advantageous embodiments of a damping mechanism according to the invention and a percussion instrument equipped therewith. In clarification, a percussion instrument according to the invention will be further elucidated with reference to the drawing, in which:

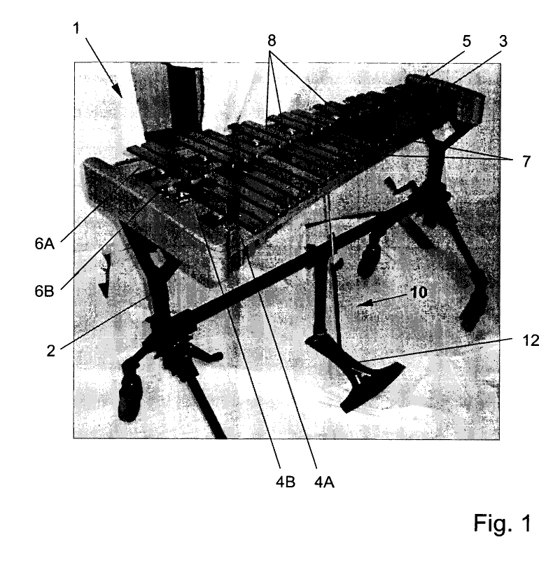

FIG. 1 shows in perspective view a glockenspiel according to the invention, provided with two rows of bars, differing in height and partly overlapping each other, and operating means for operation of a damping mechanism arranged under the bars;

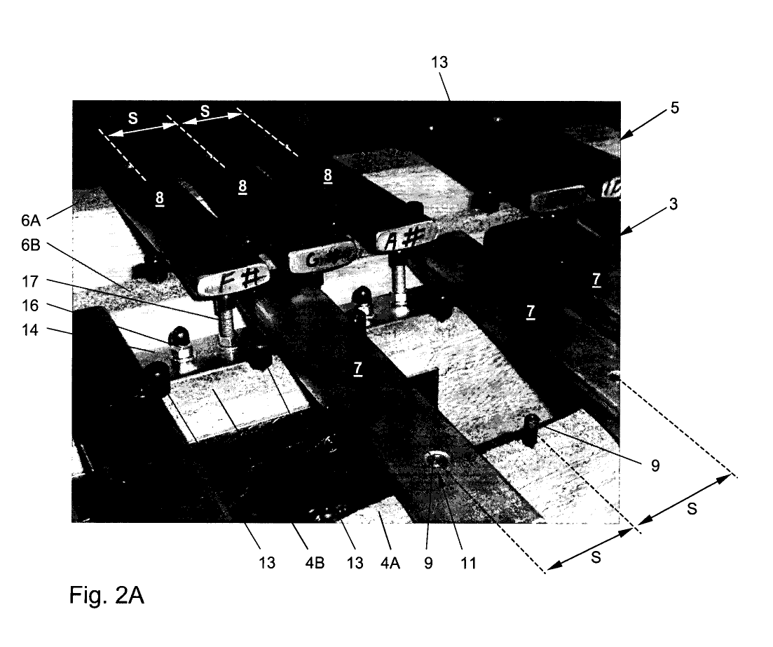

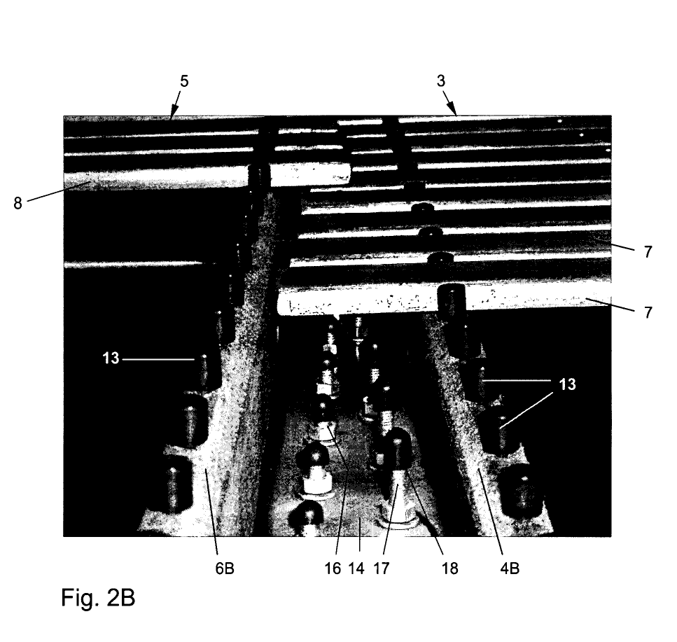

FIGS. 2A,B show an enlargement of the rows of bars from FIG. 1, in perspective top plan view and perspective side view, respectively, with a number of bars removed, so that the underlying support construction and damping beam are visible;

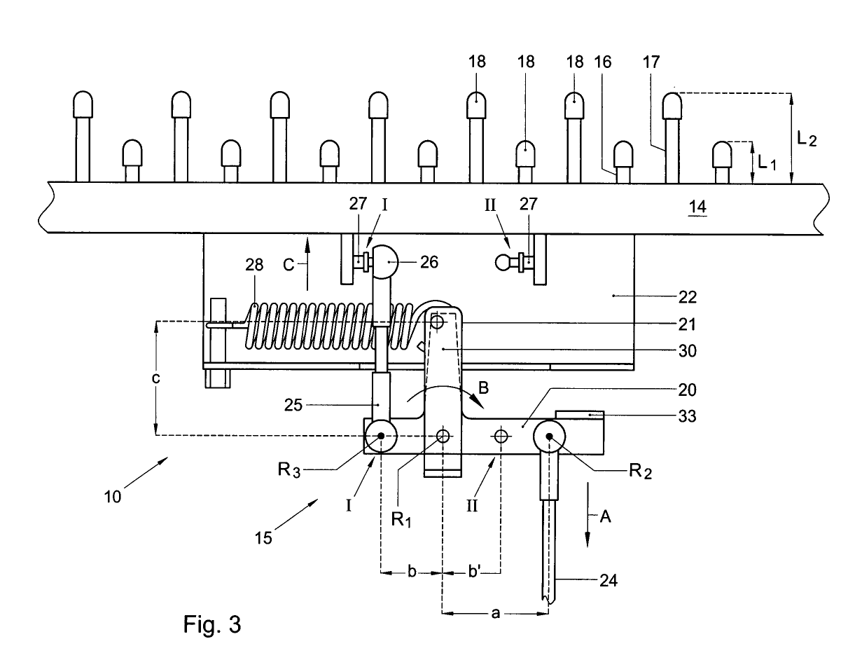

FIG. 3 shows in front view, and in further detail, the operating means and conversion means of a damping mechanism according to the invention;

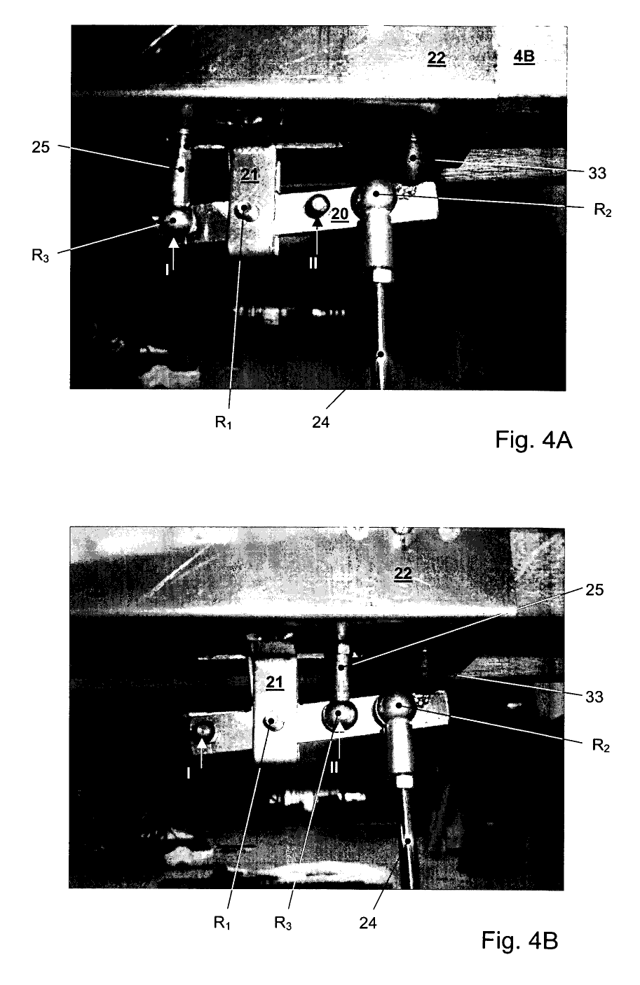

FIG. 4A shows the operating means from FIG. 3 with the conversion means in a first location, whereby the percussion instrument is standardly not damped, but can at least temporarily be damped with the operating means;

FIG. 4B shows the operating means according to FIG. 3 with the conversion means in a second location, whereby the percussion instrument is standardly damped and this damping can be temporarily removed with the operating means; and

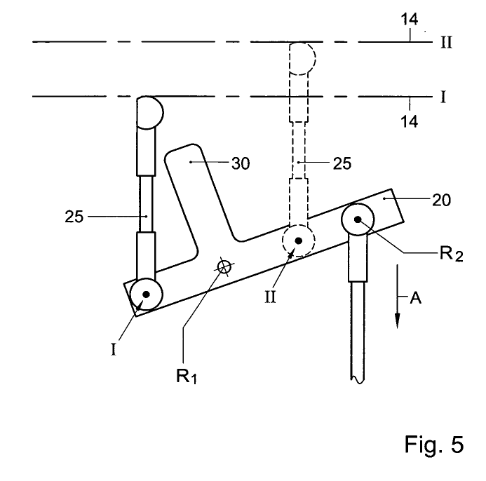

FIG. 5 schematically shows the operating means according to FIG. 3, in an inclined initial position.

In this description, the same or corresponding parts have the same or corresponding reference numerals. In this description, a damping mechanism according to the invention is described with reference to an exemplary application in a glockenspiel. It should be noted, however, that a damping mechanism according to the invention is applicable, in a same or comparable manner with a same objective and advantage, to similar percussion instruments provided with one or more rows of bars, such as a vibraphone, marimba or xylophone.

FIG. 1 shows in perspective view a glockenspiel 1 according to the invention, comprising a first row of bars 3, laid onto a first pair of substantially horizontal supporting beams 4A,B, and a second row of bars 5, laid onto a second pair of supporting beams 6A,B. The bars 7 of the first row 3 can for instance represent whole tones, the bars 9 of the second row 5 for instance half-tones. Preferably, the supporting beams 4A,B; 6A,B are mounted on a frame 2 such that the second row of bars 5 is situated slightly higher than the first row of bars 3 and partly overlaps this first row 3. The glockenspiel 1 further comprises a damping mechanism 10 (of which in FIG. 1 only the operating means 12 are visible) for damping out vibrations generated in the bars 7,8 when the glockenspiel 1 is being played. This damping mechanism 10 will be described in detail hereinbelow with reference to FIGS. 3 and 4A,B.

In FIGS. 2A and 2B it is shown more clearly how the bars 7,8 have been laid onto the supporting beams 4, 6. The two outermost supporting beams 4A,6A are provided, at regular intermediate distances S, with supporting pins 9, to which the bars 7, 8 are attached by way of an opening 11, provided at their end for that purpose. Furthermore, at their opposite ends, the bars 7, 8 rest on the inner beams 4B, 6B, between spacer lugs 13 provided for that purpose, which are arranged at the same regular mutual distance S, though staggered relative to the supporting pins 9 by half a pitch S. By virtue of the supporting pins 9 and spacer lugs 13, the position of the bars 7, 8 is defined uniformly and they can be simply removed and/or exchanged. The spacer lugs 13 ensure that there is always sufficient space between bars located next to each other, the importance of which will become clear hereinbelow. Furthermore, in particular FIG. 2A clearly shows that the spacer lugs 13 of one pair of supporting beams 4, 6 are located substantially diametrically opposite the supporting pins 9 of the other pair of supporting beams 6, 4, so that the bars 8 of the upper row 5 are staggered by substantially half a bar width relative to the bars 7 of the lower row 3.

Depending on the type of percussion instrument, the bars 7, 8 can for instance be manufactured from metal, such as steel (glockenspiel), aluminum (vibraphone) or wood (marimba, xylophone). Further, under the bars, resonators and/or vibration means may be provided, which will not be described further here.

In the embodiment shown (see FIGS. 2A,B and 3), the damping mechanism 10 comprises a damping body 14 in the form of a beam, which extends between the inner supporting beams 4B, 6B, under the mutually overlapping bars 7, 8. The damping mechanism 10 furthermore comprises operating means 15 for moving the damping beam 14 between a damped position in which it abuts against the bars 7, 8 and an undamped position in which it is clear of the bars 7, 8. To that end, the damping beam 14 is movably suspended from the frame 2, for instance pivotably by means of pivoting arms, not shown, at the ends of the beam 14, or translatably by means of, for instance, lugs, not shown, adjacent the ends of the beam 14, which may be slidably received in guide rails or slots of the frame 2, provided for that purpose.

The damping beam 14 is provided, on a side facing the bars 7, 8, with a series of alternating short and long pins 16, 17, having respective lengths L₁, L₂, with the long pins 17 being substantially in one line with the spacer lugs 13 on the inner supporting beam 4B of the first row of bars 3, as is perhaps to be seen most clearly in FIG. 2A. The long pins 17 moreover have a cross section which is dimensionally at most equal to and preferably slightly smaller than that of the spacer lugs 13, so that the pins 17, like these spacer lugs 13, can extend between the bars 7 of the first row 3. Thus, these pins 17 can form a partial surface for the higher, second row of bars 5, which partial surface in a damped position can abut against the bars 8 in order to damp vibrations generated therein.

At the same time, the short pins 16 can jointly form a second partial surface, which in a damped position can abut against the lower, first row of bars 3. The short pins 16 are preferably in one line with the spacer lugs 13 on the inner supporting beam 6B of the second row of bars 5. Accordingly, in damped position, these pins 16 will abut centrally against the bars 7. The cross section of the short pins 16 in this case does not need to be smaller than that of the spacer lugs 13, since the pins 16 do not need to extend between bars 7, 8.

By virtue of the pins 16, 17, rows of bars 3, 5 differing in height and overlapping each other can be adequately damped, with a single, compact damping body 14. In addition, the bars of both rows can be damped adjacent their overlapping ends, by virtue of the pins 17 extending between the lower bars 7.

The short and long pins 16, 17, seen in top plan view, can be in one line, but can also be staggered relative to each other, as shown in FIG. 2B. Preferably, at least the end of the pins 16, 17 by which, in damped position, they abut against the bars 7, 8 is covered with a layer of relatively soft, damping material 18, such as plastic, rubber or cloth, for instance felt. The pins 16, 17 can for instance be formed by bolts or threaded ends, as shown in FIGS. 2A,B, while the ends are provided with a plastic cap 18. Of course, many other embodiments are possible. For instance, the pins 16, 17 can be wholly or partly manufactured from plastic, rubber or wood and be mounted in or to the damping beam 14 e.g. by pressing, gluing, welding, or the like.

The operating means 15 comprise a pivoting arm 20, which is pivotably suspended by a first mounting bracket 21 from a second mounting bracket 22, which in turn is mounted under the damping beam 14, to one or both inner supporting beams 4B, 6B (not visible in FIG. 3, but see FIGS. 4A,B), such that a pivot R₁ of the pivoting arm 20 extends centrally under the damping beam 14, substantially at right angles to the longitudinal direction thereof, in substantially horizontal direction.

Adjacent a first end 31, the pivoting arm 20 is pivotably connected with a pull rod 24, about a second pivot R₂ extending substantially parallel to the first pivot R₁, a distance ‘a’ spaced therefrom. Adjacent an operatively lower end, the pull rod 24 is provided with a pedal 12 (see FIG. 1). Furthermore, the pivoting arm 20 is provided, on opposite sides of the first pivot R₁, with a first and second mounting location I, II, for pivotably mounting a connecting rod 25, about a third pivot R₃ extending substantially parallel to the first and second pivot R₁, R₂. The connecting rod 25 can be pivotably mounted by another end to the damping beam 14, preferably via a ball hinge 26. To that end, at two mounting locations I, II, the damping beam 14, like the pivoting arm 20, is provided with mounting parts 27 cooperating with the ball hinge 26.

Furthermore, biasing means 28 are provided, in the form of a draw spring, which is mounted between the second mounting bracket 22 and a side arm 30 of the pivoting arm 20 (represented in broken lines in FIG. 3). The biasing force and/or a distance c between the biasing means 28 and the first pivot R₁ is preferably chosen such that a biasing moment exerted by these biasing means 28 on the pivoting arm 20 is greater than a counter moment exerted on the pivoting arm 20 by the damping beam 14 via the connecting rod 25, when the connecting rod 25 is in the second mounting location II. What is then achieved is that the pivoting arm 20 in unoperated position assumes an inclined initial position (as represented in FIG. 5), whereby the arm end 31 connected to the pull rod 24 is situated higher than the two mounting locations I, II, and preferably abuts against the second mounting bracket 22. If desired, the pivoting arm 20 and/or the second mounting bracket 22 can be provided, adjacent their contact surface, with a preferably slightly resilient stop element 33, such as a rubber pad, as shown in FIGS. 4A,B. In this way, a pivotal movement towards the above-mentioned inclined initial position initiated by the biasing means 28 can be stopped in a controlled manner. In addition, or alternatively, a similar stop element may be provided in or adjacent the path of movement of the damping beam 14, in order to limit an upward and/or downward stroke thereof.

It should be noted that when the connecting rod 25 is situated in the first mounting location I, strictly speaking, no biasing means 28 are needed to bias the pivoting arm 20 in the inclined initial position, since in that case a moment exerted by the damping beam 14 via the connecting rod 25 on the pivoting arm 20 will ensure that the pivoting arm 20 is ‘biased’ into the initial position referred to.

It will now be explained with reference to FIGS. 3-5 how the above operating mechanism 15 works. This depends on the mounting location of the connecting rod 25, as schematically illustrated in FIG. 5. If it is mounted at the second location II, as represented in broken lines in FIG. 5, then the damping beam 14 (II) in the inclined initial position shown will be situated higher than when the connecting rod 25 is situated in the first mounting location I, as represented in FIG. 5 in full lines (see damping beam 14 (I)). The operating mechanism 15 is so dimensioned that the damping beam 14 abuts against the bars 7, 8 when the connecting rod 25 is mounted in the second location II, and is clear of the bars 7, 8 when the connecting rod 25 is mounted in the first location I.

When presently the pedal 12 is depressed and the pull rod 24 is thus moved downwards, as indicated by arrow A (FIG. 3), the pivoting arm 20 is pivoted clockwise, as indicated by arrow B, against the biasing force. As a result, the connecting rod 25, when it is situated in the first mounting location I, is moved up, as indicated by arrow C, and the damping beam 14 will be moved up from the undamped initial position, against the bars 7, 8. If, by contrast, the connecting rod 25 is situated in the second mounting location II, then, as appears from FIG. 3, the connecting rod 25, upon depression of pedal 12, will be moved down, in the same direction as the pull rod 24, because both (connecting rod 25 and pull rod 24) are situated on the same side of the first pivot R₁. As a result, the damping beam 14 will be moved down from the damped, abutting position and come to lie clear, so that the bars 7, 8 are no longer damped.

The above therefore makes it clear that the connecting rod 25 can serve as conversion means, enabling the initial damping situation of the percussion instrument 1 to be set. Thus, prior to a performance, a musician can set the desired damping situation, by mounting the connecting rod 25 at the proper location I, II. If the piece of music requires prolonged damping, then it is advisable to mount the connecting rod 25 at the second location II, whereby the percussion instrument 1 is standardly damped. Conversely, if the piece of music requires brief damping, then it is advantageous to mount the connecting rod 25 to the pivoting arm 20 in the first location I, in which the damping beam 14 is standardly clear of the bars 7, 8.

In the exemplary embodiment shown, the distance b, b′ from the first and second mounting locations I, II, respectively, to the first pivot R₁ has been chosen to be substantially equally large. This provides the advantage that for operation of the damping beam 14, the pedal 12 must each time be depressed over substantially the same distance, regardless of whether damping is being set or being removed. Of course, these distances b, b′ do not need to be equally large. Furthermore, the moment exerted on the pivoting arm 20 by the biasing means 28 can be varied by varying the distance c between the point of application of these biasing means 28 and the pivot R₁ of the arm 20 and/or by varying the biasing force exerted by these means. Also, the distance ‘a’ between the pivot R₂ of the pull rod 24 and the pivot R₁ of the pivoting arm 20 can be adjusted, in particular enlarged, in order to thereby obtain a more favorable transmission ratio, and to reduce the operating forces.

It will be clear that the above-described principle, whereby the initial damping situation can be converted by moving the connecting rod 25, can be realized in many other ways. Moreover, this principle can also be applied with advantage to a damping mechanism 10 for a single row of bars or more rows of bars situated at equal height.

The invention is not limited in any way to the exemplary embodiments shown in the description and the drawing. All combinations of (parts of) embodiments described and/or shown are understood to fall within the concept of the invention. Moreover, many variations thereon are possible within the framework of the invention outlined by the claims.

For instance, the pins for damping the upper row of bars do not necessarily need to reach up between the bars of the lower row. Alternatively, these pins can abut against a part of the upper bars that is situated next to the area of overlap, if for that purpose sufficient space is available between the inner supporting beam of this upper row and the ends of the bars of the lower row. Alternatively, with an arch construction from the damping body, the pins can be passed under the supporting beam, in order to abut against a part of the upper bars situated between the two supporting beams 6A,B.

These and many other variations are understood to fall within the framework of the invention as set forth in the following claims.

1. A percussion instrument (1), such as for instance a glockenspiel, xylophone, vibraphone or marimba, comprising at least two rows of bars (3, 5) arranged next to each other, and a damping mechanism (10) for damping vibrations generated in the bars (7, 8) when the instrument (1) is being played, the damping mechanism (10) comprising a damping body (14), which can abut by a contact surface against the bars (7, 8), while the rows of bars (3, 5) mutually differ in height, and the contact surface comprises at least two partial surfaces, of which a first partial surface is arranged to abut against a first row of bars (3) and a second partial surface is arranged to abut against a second, higher row of bars (5).

2. A percussion instrument (1) according to claim 1, wherein the bars (8) of a higher row (5) are staggered relative to the bars (7) of a lower row (3) and at least partly overlap these lower bars (7), while the damping body (14) extends under the bars (7, 8), in particular under the area of overlap thereof.

3. A percussion instrument (1) according to claim 1, wherein a partial surface for damping the higher bars (8) extends at least partly between the lower bars (7).

4. A percussion instrument (1) according to claim 1, wherein the partial surfaces are formed from pins (16, 17) of different lengths (L₁, L₂), which extend from the damping body (14) towards the bars (7, 8) to be damped.

5. A percussion instrument (1) according to claim 4, wherein pins (17) for damping the higher bars (8) extend at least partly between the lower bars (7).

6. A percussion instrument (1) according to claim 4, wherein per bar to be damped, at least one and preferably at most one pin (16, 17) is provided.

7. A percussion instrument (1) according to claim 4, wherein the pins (16, 17), or at least a free end thereof, are covered with a layer of relatively soft material (18), such as (natural or synthetic) rubber, plastic or cloth, for instance felt.

8. A percussion instrument (1), optionally according to claim 1, comprising at least one row of bars (3, 5) and a damping body (14) arranged thereunder, which is biased into either a first, damped initial position, in which the damping body (14) abuts against said bars (7, 8), or a second, undamped initial position, in which the damping body (14) is clear of these bars (7, 8), and wherein operating means (15) are provided to bring the damping body (14) at least temporarily out of said first or second initial position, characterized in that conversion means (25) are provided, arranged to change the initial position, as desired, between the first, damped and the second, undamped initial position.

9. A percussion instrument (1) according to claim 8, wherein the operating means (15) comprise a pivoting arm (20), pivotable about a first pivot (R₁), and wherein the conversion means comprise a connecting rod (25) extending between the pivoting arm (20) and the damping body (14), which connecting rod (25) converts a pivoting motion of the pivoting arm (20) about said first pivot (R₁) to a substantially translating movement of the damping body (14), the connecting rod (25) being mountable on the pivoting arm (20), as desired, at least two mutually spaced apart locations (I, II).

10. A percussion instrument (1) according to claim 9, wherein the mounting locations (I, II) are situated on opposite sides of the first pivot (R₁).

11. A percussion instrument (1) according to claim 9, wherein the mounting locations (I, II) are situated at a substantially equal distance (b, b′) from the first pivot (R₁).

12. A percussion instrument (1) according to claim 9, wherein the damping body (14) comprises a first and second mounting provision (27), arranged for mounting the connecting rod (25) when it is mounted on the pivoting arm (20), at the first and second mounting location (I, II), respectively.

13. A percussion instrument (1) according to claim 9, wherein the connecting rod (25) comprises a ball hinge, for attachment to the damping body (14).

14. A percussion instrument (1) according to claim 8, wherein the operating means (15) comprise biasing means (28), which act on the pivoting arm (20).

15. A percussion instrument (1) according to claim 8, wherein stop means (33) are provided, in order to limit a pivoting angle of the pivoting arm (20) and/or a stroke of the damping body (14).
